(19) United States
(12) Patent Application Publication
(10) Pub. No.: US 2011/0070278 A1
(43) Pub. Date: Mar. 24, 2011

(54) METCONAZOLE COMPOSITIONS AND METHODS OF USE

(76) Inventor: Humberto Benito Lopez, Dublin, CA (US)

(21) Appl. No.: 12/888,244

(22) Filed: Sep. 22, 2010

Related U.S. Application Data
(60) Provisional application No. 61/244,712, filed on Sep. 22, 2009.

(51) Int. Cl. A01N 25/04; A01N 43/653; A01P 3/00

(52) U.S. Cl. 424/405; 514/383; 977/773; 977/788; 977/915

(57) ABSTRACT

The invention generally relates to fungicidal non-aqueous, dispersible concentrate (DC) compositions comprising metconazole, non-ionic surfactants, and solvents. Methods of use and ready-to-use products are also provided.

### FIELD OF THE INVENTION

The present invention generally relates to metconazole compositions and methods of use thereof.

### BACKGROUND OF THE INVENTION

Fungicides have enjoyed widespread use in commercial agriculture and have enabled an increase in crop yields and product quality. They are routinely used to control various fungi, for example, white mold and early blight, whenever these fungi pose risks to crop yield.

Metconazole is a fungicide with great fungicidal activity. It is typically formulated as a water dispersible granule (WG) or as a suspension concentrate. The WG formulation is typically made with inert compounds that have little adjuvancy and can be difficult to make bioavailable to growing crops. Furthermore, because Metconazole stays as large particles in the formulation and applications steps, a substantial amount of the formulation has to be applied per acre to control fungal infestations. A suspension concentrate formulation has the disadvantage that the particles of Metconazole in suspension in the spray mixture are typically of a large size (>1 micron) and thus provide little surface area for foliar uptake and biotranslocation, and thus a substantial amount of the formulation has to be applied per acre to control fungal infestations.

There is, therefore, a need for more efficacious metconazole formulations that would have good dispersion properties, as well as improved biological efficacy.

### BRIEF SUMMARY OF THE INVENTION

The present invention is generally directed to a non-aqueous, dispersible concentrate (DC) composition comprising from about 1.0% to about 40% by weight of metconazole (5-[(4-chlorophenyl)methyl]-2,2-dimethyl-1-(1H-1,2,4-triazol-1-ylmethyl)cyclopentanol; CAS Registry Number 125116-23-6); from about 0.1% to about 40% by weight of at least one non-ionic surfactant; and from about 20% to about 75% by weight of at least one solvent, wherein said solvent has water solubility of between about 0.1% and about 20%, and wherein the weight percentages are based on the total weight of the composition. This dispersible concentrate will form a nano-suspension of metconazole particles that are less than 30 nanometers in diameter upon dilution with water.

In a preferred embodiment, the concentration of metconazole is from about 10% to about 30% by weight.

In another embodiment, the solvent in the composition is selected from the group consisting of butyl lactate, ethyl hexyl lactate, fatty acid dimethylamide, N,N-dimethyloctanamide, and N,N-dimethyldecanamide, or a blend thereof.

In a preferred embodiment, the non-ionic surfactant is selected from the group consisting of a butyl polyalkylene oxide block copolymer, tristyrylphenol ethoxylate, an alkylphenol ethoxylate, a castor oil ethoxylate, or a blend thereof.

In another embodiment, the composition further comprises at least one anionic surfactant. In one embodiment, the anionic surfactant is a tristyrylphenol ethoxylate phosphate ester.

The invention also provides a method of preparing nano-suspensions of Metconazole by using the DC compositions of the invention. The invention also provides a ready-to-use product prepared from the DC compositions of the invention.

The invention also provides a method of protecting monocot and dicot plants, including genetically modified plants, comprising treating said plants with a pesticidally effective amount of a ready-to-use product prepared from the DC compositions of the present invention.

### DETAILED DESCRIPTION OF THE INVENTION

The present invention is generally directed to a non-aqueous, dispersible concentrate (DC) composition comprising from about 1.0% to about 40% by weight of metconazole (5-[(4-chlorophenyl)methyl]-2,2-dimethyl-1-(1H-1,2,4-triazol-1-ylmethyl)cyclopentanol; CAS Registry Number 125116-23-6); from about 0.1% to about 40% by weight of at least one non-ionic surfactant; and from about 20% to about 75% by weight of at least one solvent, wherein said solvent has water solubility of between about 0.1% and about 20%, and wherein the weight percentages are based on the total weight of the composition.

As used herein, the term “surfactant” encompasses a blend of surfactants.

The non-aqueous DC compositions of the present invention exhibit surprisingly good nano-dispersion properties, good fungicidal efficacy, and reduced fungicide use compared to other commonly used formulation types.

The DC compositions of the present invention do not include aliphatic alcohol ethoxylates.

Preferably, the solvent suitable for use in the DC compositions of the present invention is selected from the group consisting of butyl lactate, ethyl hexyl lactate, fatty acid dimethylamide, N,N-dimethyloctanamide, N,N-dimethyldecanamide, or a blend thereof.

The amount of solvent in the compositions of the present invention is from about 20% to about 75% by weight of the composition; more preferably, from about 40% to about 75% by weight of the composition, wherein the weight percentages are based on the total weight of the composition.

Presently preferred non-ionic surfactants include butyl polyalkylene oxide block copolymers, tristyrylphenol ethoxylate, alkylphenol ethoxylates, castor oil ethoxylate, or a blend thereof.

The amount of the non-ionic surfactant in the compositions of the present invention is from about 0.1% to about 40% by weight of the composition; most preferably, from about 10% to about 30% by weight of the composition.

In one embodiment, the composition further comprises at least one anionic surfactant. In one embodiment, the anionic surfactant is tristyrylphenol ethoxylate phosphate ester.

In another embodiment the invention relates to a method of forming a nano-suspension of Metconazole particles of less than 30 nanometers in diameter by dilution of a DC composition in the ratio of 1:50 to 1:25000 (DC:water) with water.

In another embodiment, the invention relates to a ready-to-use product prepared from the DC compositions of the present invention. It is well within a skill of the art to prepare such ready-to-use products using well-known techniques, such as dilutions. The dilutions may be made in water.

In a preferred embodiment, the ready-to-use product made by dilution of the composition of the present invention comprises from about 0.00004% to about 0.8% by weight of metconazole, from about 0.000004% to about 0.8% by weight of at least one non-ionic surfactant, from about 0.0008% to about 1.5% by weight of at least one solvent, wherein said solvent has water solubility of between about 1% and about 20%, and from about 96.9% to about 99.99% by weight of water, wherein the weight percentages are based on the total weight of the ready to use composition.

Generally, to prepare the ready-to-use product, the DC is diluted with water at ratios between 1:50 and 1:25000 (DC:water) by volume. In a more preferred embodiment of the invention, the composition is diluted with water at ratios between 1:100 and 1:500 (DC:water) by volume. Ratios of dilution can vary depending upon active ingredient concentration in the DC, which plant is being treated, the intensity of fungal infestation, weather conditions, and the predominant infesting fungal species, and other factors, and may be readily determined by established biological tests known to those skilled in the art.

In yet another embodiment, the invention relates to a method of treating plants comprising applying a fungicidally effective amount of ready-to-use products prepared from the DC compositions of the present invention. A person skilled in the art would readily know how to “treat” plants, as these techniques are well known in the art and are applicable to the compositions of the present invention.

The phrase “fungicidally effective amount” of the formulation means a sufficient amount of the formulation to provide the desired effect. In general, the formulation is employed in amounts that do not cause phytotoxic damage to any part of the plant. The amount of the formulation may vary depending on specific crops and other factors. It is well within an ordinary skill in the art to determine the necessary amount of the formulation.

The compositions of the invention may be used against fungi that include, but are not limited to, Alternaria, Anisogramma, Basidomycetes, Blumerialla, Botryosphaeria, Cercospora, Cladosporium, Cochliobollus, Colletotrichum, Erysiphe (Blumeria), Fusarium, Helminthosporium, Laetisaria, Magaporthe, Monilinia, Podosphaera, Puccinia, Pyrenophora, Pyricularia, Rhyncosporium, Rhizoctonia, Sclerotinia, Sclerotium, Septoria, Stagonospora, Wilsonomyces, and others.

The term “plants” is intended to be construed broadly. Plants that may be treated include, but are not limited to, cotton, citrus, pome fruit, field peas, corn, soybeans, stone fruit, tree nuts, grapes, brassica leafy vegetables, dry edible bean plants, bushberries, barley, buckwheat, canola, sorghum, crambe, sunflowers, wheat, cucurbits, grasses, safflower, potatoes, rye, flax, sugar beets, turf and ornamentals, and fruiting vegetables, or other monocot or dicot plants. Plants can be transgenic or non-transgenic plants.

In another embodiment, the ready-to-use product can be applied to plant tissue, soil, or seeds as a spray.

As used herein, all numerical values relating to amounts, weights, and the like, are defined as “about” or “approximately” each particular value, namely, plus or minus 10%. For example, the phrase “at least 5% by weight” is to be understood as “at least 4.5% to 5.5% by weight.” Therefore, amounts within 10% of the claimed value are encompassed by the scope of the claims.

As used herein, “metconazole technical” contains 97-100% by weight metconazole.

Agnique® KE 3658 is a fatty acid dimethylamide solvent available from Cognis USA, Cincinnati, Ohio 45232.

Halcomid M8-10 is a fatty acid dimethylamide solvent available from Stepan Company, Northfield, Ill. 60093.

Emulpon CO-360 is a castor oil ethoxylate non-ionic surfactant available from Akzo Nobel Surfactants, Chicago, Ill. 60607.

Makon® TSP 16 is a tristyrylphenol ethoxylate non-ionic surfactant from available from the Stepan Co., Northfield, Ill. 60093.

Microstep® H303 is an emulsifier blend available from the Stepan Co., Northfield, Ill. 60093.

Stepfac TSP-PE is a tristyrylphenol ethoxylate phosphate ester anionic surfactant and is available from the Stepan Co., Northfield, Ill. 60093.

Soprophor BSU is a tristyrylphenol ethoxylate non-ionic surfactant and is available from Rhodia, Cranbury, N.J. 08512.

Soprophor 3D33 is a tristyrylphenol ethoxylate phosphate ester anionic surfactant like 2,4,6-tris(1-phenylethyl)polyoxyethylene phosphate and is available from Rhodia, Cranbury, N.J. 08512.

Toximul® 8320 is a butyl polyalkylene oxide block copolymer non-ionic surfactant available from the Stepan Co., Northfield, Ill. 60093.

For a clearer understanding of the invention, specific examples are set forth below. These examples are merely illustrations and are not to be understood as limiting the scope and underlying principles of the invention in any way. Indeed, various modifications of the invention in addition to those shown and described herein will become apparent to those skilled in the art from the following examples and foregoing description. Such modifications are also intended to fall within the scope of the appended claims.

### EXAMPLES

### Example 1

### Formulation 1

A formulation was prepared by conventional blending techniques consisting of metconazole technical at about 20% by weight, a non-ionic surfactant Toximul® 8320 at about 13% by weight, a non-ionic surfactant Soprophor BSU at about 6% by weight, a tristyrylphenol phosphate ester Stepfac TSP PE at about 2% by weight, an amide solvent Agnique® KE 3658 at about 59% by weight, wherein the weight percentages are based on the total weight of the composition. The Metconazole technical was first dissolved into Agnique® KE 3658. Then, Toximul® 8320, Soprophor BSU, and the Stepfac TSP PE were added. The mixture was then blended until a clear homogeneous solution was obtained. The formulation had good dispersion properties forming a nano-suspension of Metconazole particles of less than 30 nanometers in size upon dilution with water and is expected to have good biological efficacy.

### Example 2

### Formulation 2

A formulation was prepared by conventional blending techniques consisting of metconazole technical at about 15% by weight, a non-ionic surfactant Toximul® 8320 at about 16% by weight, a non-ionic surfactant Makon® TSP 16 at about 8% by weight, a tristyrylphenol ethoxylate phosphate ester Soprophor 3D33 at about 1% by weight, an amide solvent, like Agnique® KE 3658, at about 30% by weight, a solvent butyl lactate at about 30% by weight, wherein the weight percentages are based on the total weight of the composition. The Metconazole technical was first dissolved into a blend of Agnique® KE 3658 and butyl lactate. Then, Toximul® 8320, Makon TSP 16, and the Soprophor 3D33 were added. The mixture was then blended until a clear homogeneous solution was obtained. The formulation had good dispersion properties forming a nano-suspension of Metconazole particles of less than 30 nanometers in size upon dilution with water and is expected to have good biological efficacy.

### Example 3

### Formulation 3

A formulation was prepared by conventional blending techniques consisting of metconazole technical at about 10% by weight, a non-ionic surfactant Toximul® 8320 at about 12% by weight, a non-ionic surfactant Makon® TSP 16 at about 8% by weight, a solvent butyl lactate at about 70% by weight, wherein the weight percentages are based on the total weight of the composition. The Metconazole technical was first dissolved into butyl lactate. Then, Toximul® 8320, and Makon TSP 16 were added. The mixture was then blended until a clear homogeneous solution was obtained. The formulation had good dispersion properties forming a nano-suspension of Metconazole particles of less than 30 nanometers in size upon dilution with water and is expected to have good biological efficacy.

### Example 4

### Formulation 4

A formulation was prepared by conventional blending techniques consisting of metconazole technical at about 23% by weight, a non-ionic surfactant Toximul® 8320 at about 15% by weight, a non-ionic surfactant Makon® TSP 16 at about 7% by weight, a tristyrylphenol ethoxylate phosphate ester Soprophor 3D33 at about 1% by weight, an amide solvent Agnique® KE 3658 at about 10% by weight, a solvent butyl lactate at about 44% by weight, wherein the weight percentages are based on the total weight of the composition. The Metconazole technical was first dissolved into a blend of Agnique® KE 3658 and butyl lactate. Then, Toximul® 8320, Makon TSP 16, and the Soprophor 3D33 were added. The mixture was then blended until a clear homogeneous solution was obtained. The formulation had good dispersion properties forming a nano-suspension of Metconazole particles of less than 30 nanometers in size upon dilution with water and is expected to have good biological efficacy.

### Example 5

### Formulation 5

A formulation was prepared by conventional blending techniques consisting of metconazole technical at about 20% by weight, a non-ionic surfactant Emulpon® CO-360 (castor oil ethoxylate) at about 15% by weight, a non-ionic surfactant Makon® TSP 16 at about 8% by weight, a solvent ethyl hexyl lactate at about 57% by weight, wherein the weight percentages are based on the total weight of the composition. The Metconazole technical was first dissolved into the ethyl hexyl lactate. Then, Emulpon CO-360 and Makon TSP 16 were added. The mixture was then blended until a clear homogeneous solution was obtained. The formulation had good dispersion properties forming a nano-suspension of Metconazole particles of less than 30 nanometers in size upon dilution with water and is expected to have good biological efficacy.

### Example 6

### Formulation 6

A formulation was prepared by conventional blending techniques consisting of metconazole technical at about 1% by weight, a non-ionic surfactant Microstep H303 at about 24% by weight, a solvent Halcomide® M 8-10 at 54% by weight, and a solvent ethyl hexyl lactate at about 21% by weight, wherein the weight percentages are based on the total weight of the composition. The Metconazole technical was first dissolved into a blend of Halcomide® M 8-10 and ethyl hexyl lactate. Then, Microstep H303 was added. The mixture was then blended until a clear homogeneous solution was obtained. The formulation had good dispersion properties forming a nano-suspension of Metconazole particles of less than 30 nanometers in size upon dilution with water and is expected to have good biological efficacy.

### Example 7

### Formulation 7

A formulation was prepared by conventional blending techniques consisting of metconazole technical at about 16% by weight, a non-ionic surfactant Emulpon® CO-360 (castor oil ethoxylate) at about 25% by weight, an anionic surfactant Stepfac TSP PE at 4% by weight, and a solvent ethyl hexyl lactate at about 55% by weight, wherein the weight percentages are based on the total weight of the composition. The Metconazole technical was first dissolved into ethyl hexyl lactate. Then Emulpon® CO-360 and Stepfac TSP PE were added. The mixture was then blended until a clear homogeneous solution was obtained. The formulation had good dispersion properties forming a nano-suspension of Metconazole particles of less than 30 nanometers in size upon dilution with water and is expected to have good biological efficacy.

### Example 8

### Formulation 8

A formulation was prepared by conventional blending techniques consisting of metconazole technical at about 23.6% by weight, a non-ionic surfactant Toximul® 8320 at about 13% by weight, a disubstituted amide solvent Agnique® KE 3658 at about 37% by weight, a tristyrylphenol ethoxylate Soprophor BSU at about 6% by weight, a tristyrylphenol ethoxylate phosphate ester Soprophor 3D33 at about 2% by weight, with the balance of butyl lactate, wherein the weight percentages are based on the total weight of the composition. The metconazole technical was first dissolved into a blend of Agnique® KE 3658 and butyl lactate. Then, Toximul® 8320, Soprophor BSU, and the Soprophor 3D33 were added. The mixture was then blended until a clear homogeneous solution was obtained. The formulation had good dispersion properties forming a nano-suspension of metconazole particles of less than 30 nanometers in size upon dilution with water.

### Example 9

A storage stability study conducted on the composition of Example 8 shows that compositions of the present invention have excellent chemical stability and dispersion properties under a wide range of storage conditions.

TABLE 1
Stability of Metconazole DC Formulation

| Storage | | Assay | | Density | Moisture | ***Bloom | Bloom |
|---|---|---|---|---|---|---|---|
| condition | pH | (%) | Appearance | (g/cc) | (%) | (342 ppm) | (1000 ppm) |
| Initial | N/A | N/A | Transparent | N/A | N/A | G* | G |
| | | | Amber | | | | |
| 1 month | 3.87 | 23.1 | Transparent | 1.00430 | 0.6800 | G | G |
| Freezer | | | Amber | | | | |
| 1 month | 4.06 | 23.3 | Transparent | 1.00433 | 0.7424 | G | G |
| RT | | | Amber | | | | |
| 1 month | 3.90 | 23.2 | Transparent | 1.00429 | 0.7462 | N/A | N/A |
| 40 C. | | | Amber | | | | |
| 1 month | 3.77 | 23.1 | Transparent | 1.00438 | N/A | G | G |
| 50 C. | | | Amber | | | | |
| 3 month | 3.90 | 0.23 | Transparent | 1.00480 | 0.6886 | E** | E |
| RT | | | Amber | | | | |
| 3 month | 3.88 | 22.9 | Transparent | 1.00480 | 0.7932 | E | E |
| 40 C. | | | Amber | | | | |
| 6 month | 4.36 | 22.8 | Transparent | 1.00446 | 0.6715 | E | E |
| Fr | | | Amber | | | | |
| 6 month | 3.92 | 22.9 | Transparent | 1.00443 | 0.6538 | E | E |
| RT | | | Amber | | | | |
| 6 month | 3.91 | 23.0 | Transparent | 1.00450 | 0.5944 | E | E |
| 40 C. | | | Amber | | | | |

*G = Good
**E = Excellent
***Bloom refers to the spontaneity for forming dispersion upon dilution

TABLE 2**
Dispersion stability of Metconazole DC Formulation

| | | Dilution | | | | | |
|---|---|---|---|---|---|---|---|
| Storage | Water | (H2O/DC | | | | | Re-invert |
| condition | Hardness | sample) | 30 min | 60 min | 2 hrs. | 24 hrs. | +30 min. |
| Initial | 342 | 99/1 | A* | A | A | A | A |
| | 1000 | 99/1 | A | A | A | A | A |
| 1 month, | 342 | 99/1 | A | A | A | A | A |
| freezerr | 1000 | 99/1 | A | A | A | A | A |
| 1 month, | 342 | 99/1 | A | A | A | A | A |
| room | 1000 | 99/1 | A | A | A | A | A |
| temperature | | | | | | | |
| 1 month, 40° C. | 342 | 99/1 | A | A | A | A | A |
| | 1000 | 99/1 | A | A | A | A | A |
| 1 month, 50° C. | 342 | 99/1 | A | A | A | A | A |
| | 1000 | 99/1 | A | A | A | A | A |
| 3 months, | 342 | 99/1 | A | A | A | A | A |
| room | 1000 | 99/1 | A | A | A | A | A |
| temperature | | | | | | | |
| 3 months, | 342 | 99/1 | A | A | A | A | A |
| 40° C. | 1000 | 99/1 | A | A | A | A | A |
| 6 months, | 342 | 99/1 | A | A | A | A | A |
| freezer | 1000 | 99/1 | A | A | A | A | A |
| 6 months, | 342 | 99/1 | A | A | A | A | A |
| room | 1000 | 99/1 | A | A | A | A | A |
| temperature | | | | | | | |
| 6 months, | 342 | 99/1 | A | A | A | A | A |
| 40° C. | 1000 | 99/1 | A | A | A | A | A |

*A = excellent dispersion with no separation, sedimentation or creaming
**The test in Table 2 consists of diluting the DC formulation with water in a 100 ml cylinder and mixing by inverting the cylinder 30 times and observing the dispersion properties up to 24 hours after which time the cylinder is re-inverted and an observation is done after 30 minutes.

### Example 10

Effect of Quash 50 WG and Quash 2 DC on white mold and Aschochyta blight on field peas.

TABLE 3

| | | |
|---|---|---|
| Crop | Field Pea | |
| Disease(s) | White mold | Ascochyta blight |

| | | Weight ounces | | | | White | Weight of |
|---|---|---|---|---|---|---|---|
| | Active | of | | Ascochyta blight | White mold | mold pest | 100 peas |
| Treatments | ingredient | active/Acre | Vigor* | % incidence** | % incidence** | severity*** | (grams)+ |
| Untreated | None | 0.0 | 20.0 | 80.0 | 60.0 | 5.8 | 130.0 |
| check | | | | | | | |
| Endura 70 | Boscalid | 5.6 | 50.0 | 56.3 | 30.0 | 3.0 | 134.0 |
| WG\hat{ } | | | | | | | |
| Quash 50 | Metconazole | 1.5 | 71.3 | 51.3 | 27.5 | 2.8 | 156.0 |
| WG\hat{ }\hat{ } | | | | | | | |
| Quash 50 | Metconazole | 3.0 | 71.3 | 38.8 | 22.5 | 2.3 | 156.0 |
| WG | | | | | | | |
| Quash 2 | Metconazole | 1.5 | 62.5 | 40.0 | 25.0 | 2.3 | 155.0 |
| DC\hat{ }\hat{ }\hat{ } | | | | | | | |
| Quash 2 DC | Metconazole | 3.0 | 88.8 | 27.5 | 5.0 | 0.5 | 174.0 |

*Vigor is an indicator of plant health, 100 is best
**less disease incidence is preferable
***Less severity is desirable scale is from 0 to 10
+higher weight is desirable
\hat{ }Endura 70 WG is a 70% w/w boscalid fungicide from BASF Corporation
\hat{ }\hat{ }Quash 50 WG is a 50% w/w Metconazole Wettable granule from Valent U.S.A. Corporation
\hat{ }\hat{ }\hat{ }Quash 2 DC is a 2 pound per gallon Metconazole DC formulation described in Example 8

The fungicide applications were made by diluting the appropriate amount of product into 17 gallons of water and spraying with a Twinjet8 nozzle at 35 psi.

The experiment demonstrated that DC compositions of the present invention, especially at 3 ounces of active per acre, were very efficacious in significantly reducing the amount of blight incidence and white mold incidence and severity as compared to untreated control and water dispersible granules (WG) Metconazole compositions as well as the standard Endura 70 WG.

### Example 11

Effect of Quash 2 DC on potato early blight, anthracnose and white mold.

TABLE 4

| | | | |
|---|---|---|---|
| Crop | Potato | Early blight | White mold |
| Disease(s) | Anthracnose | (alternaria) | (sclerotinia) |

| | | | Alternaria solani | | | |
|---|---|---|---|---|---|---|
| | | Weight ounces | severity, one | Sclerotinia | | Potato yield in |
| | | of | month after | Sclerotiorum | Anthracnose | Hundredweight** |
| Treatments | Active ingredient | active/Acre | application* | severity* | severity* | per acre |
| Untreated check | None | 0.0 | 40.0 | 25.8 | 46.3 | 361.0 |
| Quash 50 WG\hat{ }\hat{ } | Metconazole | 2.0 | 18.8 | 17.0 | 16.5 | 346.0 |
| Quash 2 DC\hat{ }\hat{ }\hat{ } | Metconazole | 2.0 | 15.0 | 17.8 | 19.3 | 367.0 |
| Quash 50 WG | Metconazole | 4.0 | 17.5 | 18.5 | 10.0 | 375.0 |
| Quash 2 DC | Metconazole | 4.0 | 8.8 | 13.8 | 8.5 | 463.0 |
| Endura 70 WG\hat{ } | Boscalid | 3.9 | 10.8 | 7.5 | 7.5 | 386.0 |

*less disease severity is preferable, scale 0 to 100
**One hundredweight is equal to 45.35 Kg
\hat{ }Endura 70 WG is a 70% w/w boscalid fungicide from BASF Corporation
\hat{ }\hat{ }Quash 50 WG is a 50% w/w Metconazole wettable granule formulation from Valent U.S.A. Corporation
\hat{ }\hat{ }\hat{ }Quash 2 DC is a 2 pound per gallon Metconazole DC formulation described in Example 8

Spray applications were made by diluting the appropriate amount of material in 40 gallons of water and spraying with a TeeJet 8 nozzle at 40 psi. The experiment demonstrated that DC compositions of the present invention, especially at 4 ounces of active per acre, were very efficacious in significantly reducing the amount of fungal disease severity as compared to untreated control and water dispersible granules (WG) Metconazole compositions as well as the standard Endura 70 WG.

### Example 12

Effect of Quash 50 WG and Quash 2 DC on Cladosporium and liver spot on pecan trees.

TABLE 5

| | |
|---|---|
| Crop | Pecan |
| Disease(s) | Cladosporium |

| | | Weight ounces | | | |
|---|---|---|---|---|---|
| | | of | Cladosporium | Area under | Liver spot |
| Treatments | Active ingredient | active/Acre | severity* | disease curve** | severity* |
| Untreated check | None | 0.0 | 12.0 | 1186.0 | 12.8 |
| Quash 50 WG\hat{ }\hat{ } | Metconazole | 2.0 | 6.4 | 351.0 | 0.0 |
| Quash 2 DC\hat{ }\hat{ }\hat{ } | Metconazole | 2.0 | 3.9 | 217.0 | 0.0 |
| Quash 3.7 SC\hat{ } | Metconazole | 2.8 | 5.7 | 359.0 | 0.3 |

*less disease severity is preferable, scale 0 to 100
**The greater the area the greater the disease
\hat{ }Quash 3.7 SC is a 3.7 pounds per gallon Metconazole formulation
\hat{ }\hat{ }Quash 50 WG is a 50% w/w Metconazole wettable granule formulation from Valent U.S.A. Corporation
\hat{ }\hat{ }\hat{ }Quash 2 DC is a 2 pound per gallon Metconazole DC formulation described in Example 8

Spray applications were made by diluting the appropriate amount of material in 100 gallons of water and spraying with an air blast sprayer.

The experiment demonstrated that DC compositions of the present invention were very efficacious in significantly reducing the amount of fungal disease severity as compared to untreated control and water dispersible granules (WG) and suspension concentrate (SC) Metconazole compositions.

### Example 13

Effect of Quash 50 WG and Quash 2 DC on white mold (Sclerotinia) on Canola.

TABLE 6

| | |
|---|---|
| Crop | Canola |
| Disease(s) | White mold (sclerotinia) |

| | | Weight | Yield | Weight of | Sclerotinia | Sclerotinia |
|---|---|---|---|---|---|---|
| | | ounces of | (pounds/ | 1000 | Sclerotiorum | Sclerotiorum |
| Treatments | Active ingredient | active/Acre | acre) | seeds (kg) | incidence* | severity* |
| Untreated check | None | 0.0 | 1248.0 | 2.74 | 34.0 | 4.3 |
| Endura 70 WG\hat{ } | Boscalid | 5.4 | 1389.0 | 2.88 | 23.0 | 1.5 |
| Quash 50 WG\hat{ }\hat{ } | Metconazole | 1.0 | 1475.0 | 2.90 | 26.0 | 3.3 |
| Quash 50 WG | Metconazole | 2.0 | 1575.0 | 2.66 | 21.0 | 2.9 |
| Quash 50 WG | Metconazole | 4.0 | 1567.0 | 2.65 | 9.0 | 2.6 |
| Quash 2 DC\hat{ }\hat{ }\hat{ } | Metconazole | 2.0 | 1603.0 | 2.78 | 10.0 | 2.6 |

*less disease incidence is preferable, scale 0 to 100
*less disease severity is preferable (scale 0 to 5)
\hat{ }Endura 70 WG is a 70% w/w boscalid fungicide from BASF Corporation
\hat{ }\hat{ }Quash 50 WG is a 50% w/w Metconazole wettable granule formulation from Valent U.S.A. Corporation
\hat{ }\hat{ }\hat{ }Quash 2 DC is a 2 pound per gallon Metconazole DC formulation described in Example 8

Spray applications were made by diluting the appropriate amount of material in 18 gallons of water and spraying using a TJ8002 nozzle.

The experiment demonstrated that DC compositions of the present invention were very efficacious in significantly reducing the amount of fungal disease severity and incidence as compared to untreated control and water dispersible granules (WG) as well as the standard Endura 70 WG.

### Example 14

Effect of Quash 2DC on potato early blight.

TABLE 7

| | |
|---|---|
| Crop | Potato |
| Disease(s) | Early blight |

| | | Weight | Early blight | Early blight | Yield | % small | % medium | % large |
|---|---|---|---|---|---|---|---|---|
| | Active | ounces of | severity* | incidence** | (pounds) | potatoes | potatoes | potatoes |
| Treatments | ingredient | active/Acre | (2 months) | (2 months) | per plot | (<4 oz) | (4 to 10 oz) | (>10 oz) |
| Untreated check | None | 0.0 | 90.0 | 6.80 | 180.0 | 10.0 | 51.2 | 36.2 |
| Quash 50 WG\hat{ }\hat{ } | Metconazole | 1.0 | | | | | | |
| Bravo WeatherStik | Chlorothalonil | 18.0 | 77.5 | 9.30 | 198.8 | 7.6 | 35.2 | 54.0 |
| Quash 50 WG | Metconazole | 1.5 | | | | | | |
| Bravo WeatherStik | Chlorothalonil | 18.0 | 66.3 | 14.00 | 218.8 | 9.6 | 41.5 | 43.7 |
| Quash 50 WG | Metconazole | 2.0 | | | | | | |
| Bravo WeatherStik | Chlorothalonil | 18.0 | 63.8 | 13.00 | 216.3 | 7.6 | 41.0 | 48.5 |
| Endura 70 WG\hat{ } | Boscalid | 1.75 | | | | | | |
| Bravo WeatherStik | Chlorothalonil | 18.0 | 45.0 | 4.50 | 214.2 | 7.9 | 38.7 | 50.5 |
| Quash 50 WG | Metconazole | 0.5 | | | | | | |
| Bravo | Chlorothalonil | 18.0 | 90.0 | 9.50 | 192.8 | 8.1 | 43.5 | 43.7 |
| WeatherStik\hat{ }\hat{ }\hat{ }\hat{ } | | | | | | | | |
| Quash 2 DC\hat{ }\hat{ }\hat{ } | Metconazole | 1.0 | | | | | | |
| Bravo WeatherStik | Chlorothalonil | 18.0 | 66.3 | 9.80 | 210.0 | 6.8 | 44.0 | 42.3 |

*less disease severity is preferable (scale 0 to 100)
**less disease incidence is preferable (scale 0 to 100)
\hat{ }Endura 70 WG is a 70% w/w boscalid fungicide from BASF Corporation
\hat{ }\hat{ }Quash 50 WG is a 50% w/w Metconazole wettable granule formulation from Valent U.S.A. Corporation
\hat{ }\hat{ }\hat{ }Quash 2 DC is a 2 pound per gallon Metconazole DC formulation described in Example 8
\hat{ }\hat{ }\hat{ }Bravo WeatherStik is a 6 pound per gallon chlorothalonil SC formulation from Syngenta Corporation

Spray applications were made by diluting the appropriate amount of material in 18.4 gallons of water and spraying using a TeeJet nozzle.

The experiment demonstrated that DC compositions of the present invention were very efficacious in significantly reducing the amount of fungal disease severity and incidence as compared to untreated control and water dispersible granules (WG) as well as the standard Endura 70 WG.

We claim:

1. A non-aqueous, dispersible concentrate (DC) composition comprising:
a. from about 0.1% to about 40% by weight of metconazole;
b. from about 0.1% to about 40% by weight of at least one non-ionic surfactant; and
c. from about 20% to about 75% by weight of at least one solvent, wherein said solvent has water solubility of between about 0.1% and about 20%,
wherein the weight percentages are based on the total weight of the composition.

2. The composition according to claim 1, wherein the concentration of metconazole is from about 10% to about 30% by weight.

3. The composition according to claim 1, wherein the concentration of the non-ionic surfactant is from about 15% to about 30% by weight.

4. The composition according to claim 1, wherein the non-ionic surfactant is selected from the group consisting of butyl polyalkylene oxide block copolymers, tristyrylphenol ethoxylate, alkylphenol ethoxylates, castor oil ethoxylate, or a blend thereof.

5. The composition according to claim 1, wherein the composition further comprises at least one anionic surfactant.

6. The composition according to claim 5, wherein the anionic surfactant is a tristyryl phenol ethoxylate phosphate ester.

7. The composition according to claim 1, wherein the solvent comprises at least one of butyl lactate, ethyl hexyl lactate, fatty acid dimethylamide, N,N-dimethyloctanamide, and N,N-dimethyldecanamide, or a blend thereof.

8. A method for preparing a nano-dispersion of Metconazole wherein the Metconazole particle size is less than 30 nanometers in diameter in the dispersion, comprising the step of diluting the composition of claim 1 in water slowly until a suspension of nano-particles has been formed.

9. A method for increasing the fungicidal efficacy of Metconazole wherein the nano-dispersion produced in claim 8 is used to treat plants with a fungicidally effective amount.

10. A ready-to-use product prepared from the composition of claim 1.

11. The ready-to-use product of claim 10, wherein said ready-to-use product comprises:
a. from about 0.00004% to about 0.8% by weight of metconazole;
b. from about 0.000004% to about 0.8% by weight of at least one non-ionic surfactant;
c. from about 0.0008% to about 1.5% by weight of at least one solvent, wherein said solvent has water solubility of between about 1% and about 20%; and
d. from about 96.9% to about 99.99% by weight of water,
wherein the weight percentages are based on the total weight of the composition.

12. A method of protecting plants which comprises treating said plants with a fungicidally effective amount of the ready-to-use product according to claim 10.

13. The method according to claim 12, wherein said plants are monocots.

14. The method according to claim 12, wherein said plants are dicots.

15. The method according to claim 12, wherein said plants are transgenic.
